(19) United States
(12) Patent Application Publication
(10) Pub. No.: US 2008/0190555 A1
(43) Pub. Date: Aug. 14, 2008

(54) Method for Manufacturing Laminated Board and Apparatuses Used on the Same

(76) Inventor: Yiming Lee, Shishi (CN)

Correspondence Address: ERIC CHAN, 42 PIN OAKS DRIVE, PHOENIXVILLE, PA, 19460, US

(21) Appl. No.: 11/913,771

(22) PCT Filed: May 8, 2006
(86) PCT No.: PCT/CN2006/000913

§ 371 Date: Nov. 7, 2007

(30) Foreign Application Priority Data
May 11, 2005 (CN) 200510069939.4
Jul. 15, 2005 (CN) 200510084030.6

(51) Int. Cl. B29C 65/02

(52) U.S. Cl. 156/285; 156/382

(57) ABSTRACT

The present invention provides a method for manufacturing laminated board and apparatuses used on the same involving the laminated board flow-line production field, in which the method is to stack the sheets coated with binder of the laminated board up on the pressure block of the trailer carrier placed into the inside of the vacuum pressure device, to briquette the sheets coated with binder into the laminated boards by the vacuum pressure device under the vacuum condition, to secure in the fasteners on the top board to keep the pressure exerting on the stacked laminated boards after exiting the trailer carrier from the vacuum pressure device for waiting to the binder solidifying in cold or heating; to secure out the fasteners, the top board from the top side of the trailer carrier sequentially, finally take the finished laminated boards out to empty the trailer carrier for the next circulation; the apparatuses used for manufacturing the laminated board includes a vacuum pressure device for taking to briquette the laminated boards and trailer carriers comprising a pressure block, a top board, and fasteners, and conducting blocks used for heating the thermosetting binder to solidify. The present invention not only can reduce the equipment cost, but also enlarge the production scale and improve production efficiency to carry out flow-line production to meet the requirement of the market.

### BACKGROUND OF THE INVENTION

The present invention relates to a laminated board, and more especially to a method for manufacturing laminated board and the apparatuses used on the same.

In accordance with the conventional wooden laminated board, artificial stone laminated board, stone laminated board, fiberglass reinforced plastics and so on, they are widely used in decorating inner and outer of room, such as kitchens, bathrooms or wine bars and so on, among of them the description of a Chinese patent No.: 200310116851.4 reveals a method for manufacturing artificial stone laminated board, in which the stoke preparation is taken up on the worktable of the hydraulic press, such like stacking up the sheets of the laminated board on the worktable of the oil press, and pushing the oil press loaded with the stacked sheets of the laminated board into the inside of the vacuum cabinet along the track-way for vacuuming, and after releasing the oil press from the vacuum state into normal state the oil press kept in working state is pushed out from the vacuum cabinet, it will be kept in pressing state for 3˜4 hours so that the laminated board is completely solidified. Due to the carriages built on the both sides of the oil press, the stacking process will become inconvenient, and because the vacuum cabinet is used for vacuuming only and the oil press is used just for pressing, so only by pushing the oil press in or out the vacuum cabinet can the works be carried out, additionally the oil press is very heavy, so the operation is quite inconvenient as pushing in and out, and the operating efficiency is poor, additionally there is a big scale demand in the market, if there is only one oil press available, it signifies that the vacuum cabinet will be idle for 3˜4 hours in a cycle, so that this operating efficiency can not meet the requirement of the market, if increasing the number of the oil presses, the equipment investment will be increased, so how to decrease the manufacturing cost of the equipment, enlarge the production scale, fully take the advantage of the vacuum cabinet to carry out assembly line production, improve production efficiency and reduce cost are the issues expected to be solved.

### BRIEF SUMMARY OF THE INVENTION

For overcoming the shortcomings exited in the conventional technology, the main object of the present invention is to provide a method for manufacturing laminated board and the apparatuses used on the same for reducing the equipment cost, enlarging the production scale, fully taking the advantage of the vacuum cabinet to carry out assembly line production, improving the production efficiency and reducing manufacturing cost.

For archiving the objects, the method offered by the present invention includes following steps:
a) The stacking sheet and coating gum processes of each laminated board are taken on the pressure block of a trailer carrier;
b) Securing bolts on said pressure block, fitting on a top board over the bolts from upside, sequentially securing on nut;
c) Putting the trailer carrier loaded with a set of stacked laminated boards at inside of the vacuum pressure device;
d) Vacuuming air at the cavity by the vacuum pressure device;
e) Under the vacuum condition, the vacuum pressure device briquettes the stacked gummed laminated board;
f) Removing the vacuum condition from the vacuum pressure device;
g) Securing in the fasteners on the pressure block to keep the pressure on each laminated board;
h) Removing the pressure coming from the vacuum pressure device;
i) Drawing out the trailer carrier from the vacuum pressure device for making the binder solidify in cold or heating;
j) Securing out the fasteners and the top board from the pressure block, taking out the finished laminated board.

Said stacking and gumming step operated on the pressure block of the trailer carrier includes that coating blinder over the contacting surface of the sheets of the laminated board before stacking the sheets up; also includes taking plastic film to isolate two adjacent gummed laminated board as in stacking operation so as to avoid the binder exuding to glue individual laminated boards together, or sandwiching the gummed laminated board between two conducting blocks so that the thermosetting binder emitted from the conducting blocks can be transferred the heat to the binder layers between the sheets to solidify.

In this time, said bolts secured on the pressure block, the top board fit on the bolts, and the nuts secured on the bolts all are in loose configuration.

Said vacuuming step processed by the vacuum pressure device includes that the vacuum degree gets −0.1 MPa shown on the vacuum gage so as to vacuum fully at the inside of the vacuum pressure device.

Said step of putting the trailer carrier loaded with a set of stacked laminated boards at inside of the vacuum pressure device includes that after placing the trailer carrier loaded with a set of stacked laminated boards into the inside of the vacuum pressure device, by plugging the latches the combined base of the hydraulic actuating mechanism is connected to the guide pillars; then lift up the top board a bit via the connection by the hydraulic actuating mechanism so that the top board is apart from the top sheet of the laminated board more than 1 mm, 1 cm to 1 m in general, for avoiding the vacuum of the binder layer between the sheets of the laminated board affecting by the weight force coming from the top board.

Said removing the pressure coming from the vacuum pressure device step includes when the combined base of the hydraulic actuating mechanism is connected to the guide poles of the top board by plugging the latches in, if want to disconnect the connection such as drawing the latches out, firstly the pressure force coming from the hydraulic actuating mechanism has to be removed, then draw the latches out, next separate the combined base of the hydraulic actuating mechanism out from the guide poles of the top board.

To sum up, after the vacuum pressure device treats the set of laminated boards loaded on the trailer carrier in vacuuming and pressing processes, the trailer carrier is drew out from the vacuum pressure device, and the laminated boards is kept under pressure by securing in the fasters for waiting to the solidifying finishing, then next stocked trailer carrier will be placed into the inside of the vacuum pressure device, in this way, the vacuum pressure device can be used continuously in circulation for processing each set of laminated boards stacked on each trailer carrier to carry out flow-line production.

The apparatuses used for carry out above-mentioned method include a vacuum pressure device and trailer carriers, in which said vacuum pressure device integrated a vacuum device and a set of hydraulic actuating mechanism into together is comprised of a vacuum device used for exhausting out air, and hydraulic actuating mechanism used to briquette the sheets of the laminated boards stacked on the trailer carrier; said trailer carrier includes wheels used for running, a carriage used for placing a pressure block on, spring-strip suspensions connecting said carriage to the wheels respectively for damping as running, when the trailer carrier is placed into the inside of the vacuum pressure device attached with a pair of vertical bearing plates built on outer places beside the both trails parallelly, and bears the pressure coming from the vacuum pressure device, the spring-strip suspensions is distorted so that the carriage is laid on the top surfaces of the bearing plates crossly to transfer the pressure on the bearing plates; on the carriage there are a pressure block bearing all sets of laminated boards and a top board pressing all sets of laminated boards set, therein said top board can be made of light material optionally, such as cast aluminum alloy, or heavy material, such as iron, cast steel and so on; there are fasteners built on the pressure block rightly upward for matching with the pressure block and the top board separately, so as to keep pressure on the all sets of laminated boards via the top board, and locate all sets of the laminated boards and the top board; said fasteners is comprised of bolts and nuts, or other mechanism bought from the market, such as screw bolts and vacuum suction-press, screw bolts and eccentric.

The vacuum device of said vacuum pressure device also can be vacuum box, vacuum cabin or vacuum casing, said vacuum box, among of them, said vacuum box and vacuum cabin have a door individually for the trailer carrier entering and exiting, and windows facilitating to securing operation, and also have track-way providing the guide way for the trailer carrier entering and exiting, and a pair of bearing plates for bearing pressure coming from the vacuum pressure device, when the trailer carrier enters the inside of the vacuum pressure device, it is pressed down by the pressure coming from the hydraulic actuating mechanism, further to distort the spring-strip suspensions so that the carriage is laid on the top surfaces of the bearing plates crossly to transfer the pressure on the bearing plates; said vacuum casing has windows facilitating to the securing operation and seal loop at the bottom side for matching on the top surface of the pressure block in seal connection.

Said vacuum device and the press are combined into one body integrally, said presses can be located on the top side, flank or bottom side, and extended to the outside of the vacuum pressure device so as to stretch the pressure bars into the inside of the vacuum pressure device, and the joint portions of the press and the vacuum device are sealed; in this way, the press with the preferred direction is mounted on the top side of the vacuum device exposing to the outer air, and its pressure bars pass through the top wall of vacuum device stretching into the inside, and the joint portions of the press and the vacuum device are sealed, or said press is mounted into the inside of the vacuum device, and can be located on the top side, flank or bottom side, and joined with the vacuum device; said press with the preferred direction is mounted on the top side of the vacuum device connecting to the vacuum device at inner roof; said press can be a common mechanical press, or a vacuum press, or a pneumatic press, or a hydraulic press, or a press integrated with hydraulic and vacuum presses together, or a press integrated with hydraulic and pneumatic presses, or a press integrated with hydraulic and common mechanical pressed together and so on.

The pressure bars of said presses are connected to a combined base with the end for indirectly connecting to the guide pillars of the top board, said top board has said guide pillars built on the top side used for connecting to the combined base of said press, and latches used for locking or releasing the connection of the combined base and the guide pillars.

The apparatuses used for manufacturing said laminated board includes conducting blocks used for heating and solidifying the thermosetting binder layer between the sheets of the laminated board, also includes the track-way used for carrying the trailer carrier; there are conduction oil-pipes built upon said conducting block for circulating hot-oil to heat the conducting block, further to transferring the heat to the binder layers between the sheets of the laminated board via the conducting block for solidifying, coordinating to the conduction oil-pipes located at the inside of the conducting block, there are connectors fixed on the outer side wall of the vacuum box for connecting the hot-oil resource into the conducting block.

Comparing with the conventional technology, above-described technology project has following advantages:
1. due to the special design of the trailer carrier, the carriages built on the both sides are saved so as to facilitate to stacking sheets, meanwhile the volume of the trailer carrier reduced facilitates to transporting, so as to solve the interrupting operation problems of blocking coming from the both-side carriages and big volume, and the cooperation of the pressure block, the top board and the fasteners on the trailer carrier not only keeps the pressure exerting on the laminated boards, but also locates the top board on the stacked laminated boards.
2. due to the vacuum pressure device of the present invention integrated the vacuum device and press into one body, so the vacuum pressure device has two functions simultaneously of vacuuming and pressing so that the vacuum pressure device is utilized fully, additionally due to the cooperation of the pressure block, the top board and the fasteners on the trailer carrier, the trailer carrier has not to be equipped with a press on, so a vacuum pressure device can be equipped with many trailer carriers, it not only reduces the equipment cost, but also enlarges the manufacturing scale to carry out flow-line production.
3. in applying the method and the apparatuses offered by the present invention, after the vacuum pressure device treats the laminated boards stacked on the trailer carrier in vacuuming process and pressing process, the trailer carrier is drew out of the vacuum pressure device, taking the advantage of securing the fasteners in keeps the pressure exerting on the stacked laminated boards until the binder layers are solidified completely, in this time the next trailer carrier stocked with the stacked laminated boards can be placed into the inside of the vacuum pressure device, in this way the vacuum pressure device can be used circularly for treating each trailer carrier loaded with the stacked laminated boards in vacuuming and pressing processes; after the binder layers are solidified completely, remove the fasteners, the top board and the finished laminated boards from the trailer carrier to empty the trailer carrier being ready for stacking sheets of the laminated boards in next cycling, therefore the present invention not only can reduce the equipment cost, but also enlarge the production scale and improve production efficiency to carry out flow-line production to meet the requirement of the market.

### BRIEF DESCRIPTION OF THE DRAWINGS

FIG. 1 is a flow chart of the present invention.

FIG. 2 is a side view showing the trailer carrier stocked with the stacked sheets coated with the cold binder of the laminated boards of the present invention.

FIG. 3 is a side view showing the trailer carrier stocked with the stacked sheets coated with the thermosetting binder of the laminated boards of the present invention.

FIG. 4 is a front-side view showing the sealed joint of the press and the vacuum device in the vacuum pressure device of the present invention.

FIG. 5 is a side view showing the sealed joint of the press and the vacuum device in the vacuum pressure device of the present invention.

FIG. 6 is a front-side view showing the press located at inside of the vacuum box in the box vacuum pressure device of the present invention.

FIG. 7 is a side view showing the press located at inside of the vacuum box in the box vacuum pressure device of the present invention.

FIG. 8 is a front-side view showing the casing vacuum pressure device of the present invention.

FIG. 9 is a side view showing the sealed joint of the hydraulic press and the vacuum device of the present invention.

1 [symbol] trailer carrier, 2 [symbol] wheel, 3 [symbol] carriage, 4 [symbol] spring-strip suspension, 5 [symbol] pressure block, 6 [symbol] top board, 7 [symbol] guide pillar, 8 [symbol] fastener, 8.1 [symbol] bolt, 8.2 [symbol] nut, 9 [symbol] latch, 10 [symbol] laminated board, 11 [symbol] plastic film, 12 [symbol] conducting block, 12.1 [symbol] connector, 13 [symbol] hydraulic press, 13.1 [symbol] seal loop, 13.2 [symbol] pressure bar, 14 [symbol] vacuum box, 14′ [symbol] casing, 14.1 [symbol] door, 14.2 [symbol] windows, 14.3 [symbol] roof wall, 14.3′ [symbol] roof wall, 15 [symbol] combined base, 16 [symbol] track-way, 17 [symbol] bearing plate, 18 [symbol] box vacuum pressure device, 18′ [symbol] casing vacuum pressure device, 19 [symbol] seal loop, 20 [symbol] bolt

### DETAILED DESCRIPTION OF THE INVENTION

Referring to the attached drawings, following embodiments will be described minutely, within the similar mechanical structures in the different drawings will use the same notation in their own drawings as illustrating in the description. It should be stressed that following detailed description is just only demonstration that should not be understood as a strict constraint to the claimed range of the claim of the present invention.

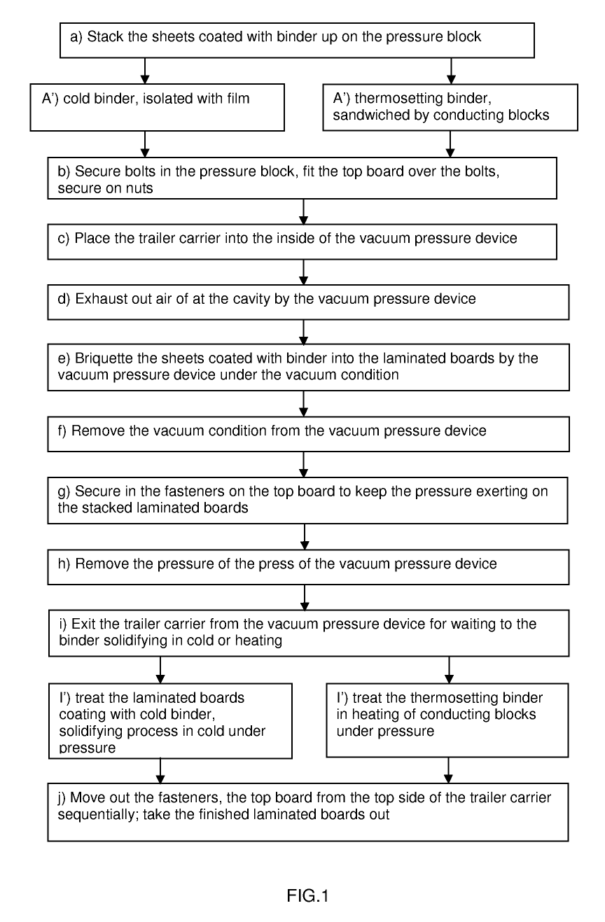

FIG. 1 is showing the steps of the method provided by the present invention:
a) stack the sheets coated with binder of the laminated board up on the pressure block of the trailer carrier;
b) secure in the blots of the fasteners on the pressure block, fit the top board over the bolts, secure on nuts;
c) place the trailer carrier stocked with the stacked laminated boards into the inside of the vacuum pressure device;
d) exhaust out air of at the cavity by the vacuum pressure device;
e) briquette the sheets coated with binder into the laminated boards by the vacuum pressure device under the vacuum condition;
f) remove the vacuum condition from the vacuum pressure device;
g) secure in the fasteners on the top board to keep the pressure exerting on the stacked laminated boards;
h) remove the pressure coming from the press of the vacuum pressure device;
i) exit the trailer carrier from the vacuum pressure device for waiting to the binder solidifying in cold or heating;
j) Move out the fasteners, the top board from the top side of the trailer carrier sequentially; take the finished laminated boards out.

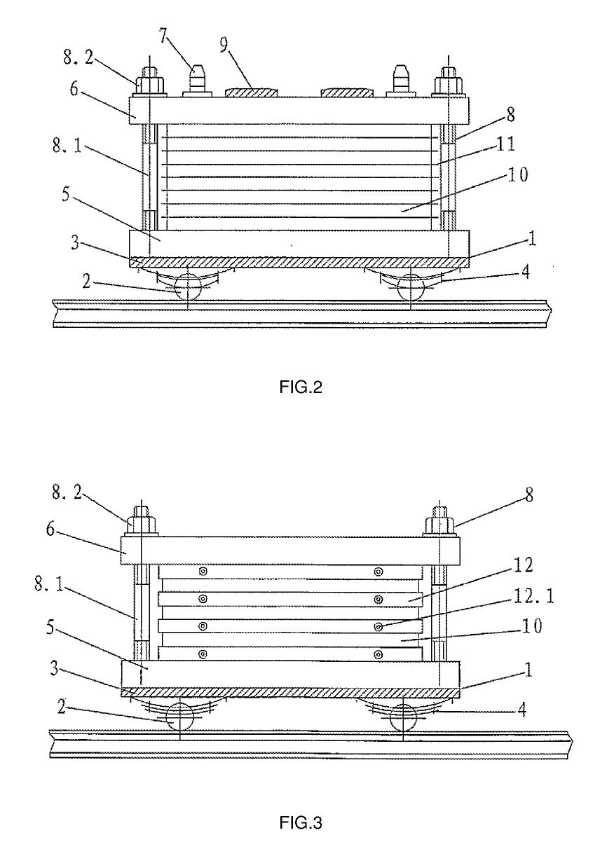

FIG. 2 is a side view showing stacking the sheets coated with cold binder upon the trailer carrier, in which the sheets coated over the cold binder are stacked up to a laminated board 10 on the pressure block 5 of the trailer carrier 1, the two adjacent laminated boards 10 are isolated by a plastic film 11 for preventing the binder from exuding to glue individual laminated boards 10 together; the trailer carrier 1 shown includes wheels 2 used for running, a carriage 3 used for placing a pressure block 5 on, spring-strip suspensions 4 connecting said carriage 3 to the wheels 2 respectively for damping as running, when the trailer carrier 1 is placed into the inside of the vacuum pressure device attached with a pair of vertical bearing plates 17 built on outer places beside the both trails 16 in parallel, and bears the pressure coming from the vacuum pressure device, the spring-strip suspensions 4 is distorted so that the carriage 3 is laid on the top surfaces of the bearing plates 17 crossly to transfer the pressure on the bearing plates 17; on the carriage 3 there are a pressure block 5 bearing all sets of laminated boards 10 and a top board 6 pressing all sets of laminated boards 10 set on, therein said top board 6 can be made of cast-iron; the top board 6 has guide pillars 7 built on the top side for connecting to the combined base 15 of the press, there are fasteners 8 built on the pressure block 5 rightly upward for matching with the pressure block 5 and the top board 6 separately, so as to keep pressure on the all sets of laminated boards 10 via the top board 6, and locate all sets of the laminated boards 10 and the top board 6; said fasteners 8 is comprised of bolts 8.1 and nuts 8.2, or other mechanism bought from the market, such as screw bolts and vacuum suction-press, screw bolts and eccentric.

FIG. 3 is a side view showing the trailer carrier stocked with the stacked the sheets coated over with thermosetting binder, in which the sheets coated over the thermosetting binder are stacked up to a laminated board 10 on the pressure block 5 of the trailer carrier 1, and conducting blocks 12 sandwiched between two adjacent laminated boards 10 are used for heating the thermosetting binder to solidify; said trailer carrier 1 shown includes wheels 2 used for running, a carriage 3 used for placing a pressure block 5 on, spring-strip suspensions 4 connecting said carriage 3 to the wheels 2 respectively for damping as running, when the trailer carrier 1 is placed into the inside of the vacuum pressure device attached with a pair of vertical bearing plates 17 built on outer places beside the both trails 16 in parallel, and bears the pressure coming from the vacuum pressure device, the spring-strip suspensions 4 is distorted so that the carriage 3 is laid on the top surfaces of the bearing plates 17 crossly to transfer the pressure on the bearing plates 17; on the carriage 3 there are a pressure block 5 bearing all sets of laminated boards and a top board 6 pressing all sets of laminated boards 10 set on, therein said top board 6 can be made of cast A-alloy; there are fasteners 8 built on the pressure block 5 rightly upward for matching with the pressure block 5 and the top board 6 separately, so as to keep pressure on the all sets of laminated boards via the top board 6, and locate all sets of the laminated boards 10 and the top board 6; said fasteners 8 is comprised of bolts 8.1 and nuts 8.2, or other mechanism bought from the market, such as screw bolts and vacuum suction-press, screw bolts and eccentric; in said conducting block 12 there are conduction oil-pipes built upon said conducting block 12 for circulating hot-oil to heat the conducting block 12, further to transferring the heat to the thermosetting binder layers between the sheets of the laminated board 10 via the conducting block 12 for solidifying, coordinating to the conduction oil-pipes located at the inside of the conducting block 12, there are connectors 12.1 fixed on the outer side wall of the vacuum box for connecting the hot-oil resource into the conducting block 12.

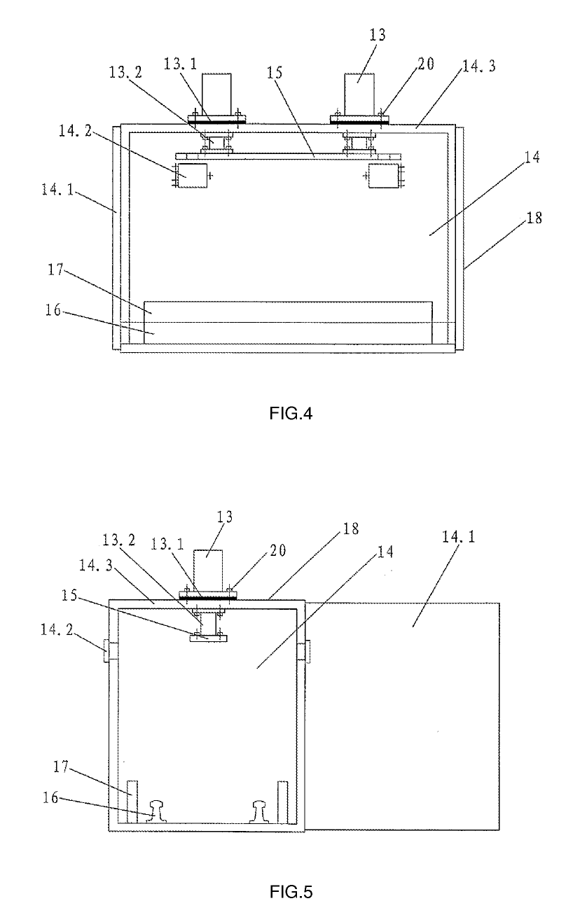

FIG. 4 and FIG. 5 are the front-side and right-side views respectively showing the sealed connection of the press and the vacuum box in the box vacuum pressure device of the present invention, they illustrate that in the box vacuum pressure device 18 of the present invention the hydraulic presses 13 are mounted on the vacuum box 14 with bolts 20 cooperating to the seal loop to combine into one body, therein the vacuum box 14 is used for exhausting air out, and the hydraulic presses 13 are used for briquette the laminated boards 10; the pressure bar 13.2 of the hydraulic press 13 passes through the roof side 14.3 of the vacuum box 14 so that the tip end of pressure bar 13.2 stretches into the inside of the vacuum box 14 to join with the combined base 15 for connecting to the guide pillars 7 of the top board 6; the vacuum box 14 has track-way 16 built on the inside providing the guide way for the trailer carrier 1 entering and exiting, and a pair of bearing plates 17 for bearing pressure coming from the hydraulic presses 13, when the trailer carrier 1 enters the inside of the vacuum pressure device 18, it is pressed down by the pressure coming from the hydraulic presses 13, further to distort the spring-strip suspensions 4 so that the carriage 3 is laid on the top surfaces of the bearing plates 17 crossly to transfer the pressure on the bearing plates 17; said vacuum box 14 has windows 14.2 facilitating to the securing operation and seal loop at the bottom side for matching on the top surface of the pressure block in seal connection; said vacuum box 14 has a door 14.1 individually for the trailer carrier 1 entering and exiting, and windows 14.2 facilitating to securing operation; said hydraulic press 13 can be a common mechanical press, or a vacuum press, or a pneumatic press, or a hydraulic press, or a press integrated with hydraulic and vacuum presses together, or a press integrated with hydraulic and pneumatic presses, or a press integrated with hydraulic and common mechanical pressed together and so on.

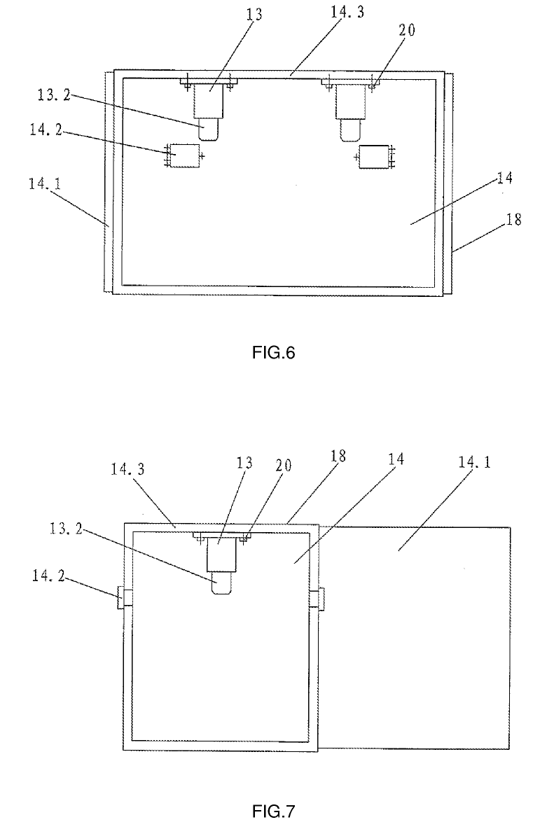

FIG. 6 and FIG. 7 are the front-side and right-side views respectively showing the hydraulic presses located on the inside of the vacuum box in the vacuum pressure device, they illustrate that in the box vacuum pressure device 18 the hydraulic presses 13 are mounted on the inside of the vacuum box 14 to be located on the roof wall 14.3 of the vacuum box 14 with bolts 20 in joint, therein the vacuum box 14 is used for exhausting air out, and the hydraulic presses 13 are used for briquette the laminated boards 10; said vacuum box 14 has a door 14.1 individually for the trailer carrier 1 entering and exiting, and windows 14.2 facilitating to securing operation; said hydraulic press 13 can be a common mechanical press, or a vacuum press, or a pneumatic press, or a hydraulic press, or a press integrated with hydraulic and vacuum presses together, or a press integrated with hydraulic and pneumatic presses, or a press integrated with hydraulic and common mechanical pressed together and so on.

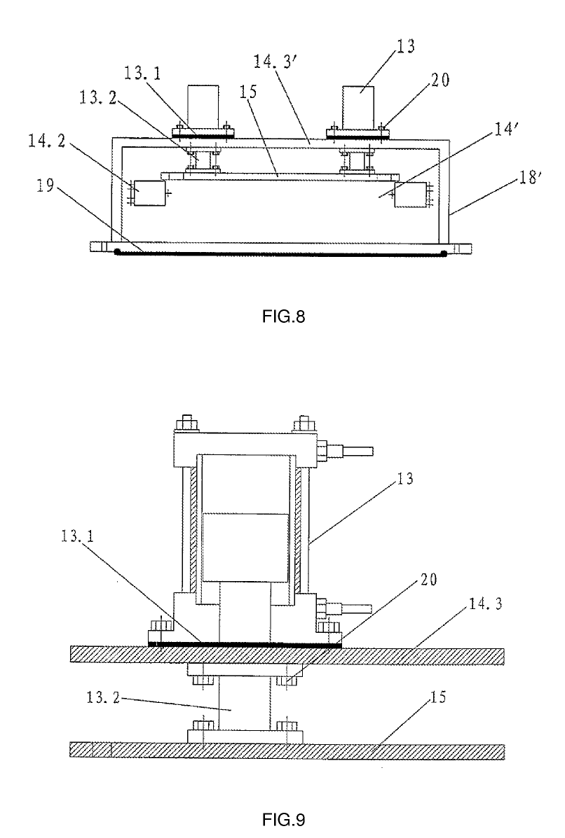

FIG. 8 is the front-side view showing the casing vacuum pressure device of the present invention, it illustrates that in the casing vacuum pressure device 18′ the hydraulic presses 13 are mounted on the vacuum casing 14′ with bolts 20 cooperating to the seal loop 13.1 to connecting into one body integrally, therein the vacuum casing 14 is used for exhausting out air, and the hydraulic presses 13 are used for briquette the laminated boards 10; the pressure bar 13.2 of the hydraulic press 13 passes through the roof side 14.3′ of the vacuum casing 14′ so that the tip end of pressure bar 13.2 stretches into the inside of the vacuum casing 14′ to join with the combined base 15 for connecting to the guide pillars 7 of the top board 6; said vacuum box 14 has windows 14.2 facilitating to the securing operation and seal loop at the bottom side for matching on the top surface of the pressure block in seal connection; said vacuum casing 14′ has windows 14.2′ facilitating to securing operation, and a seal loop 19 built upon the bottom engaging with the pressure block 5 for connection; said hydraulic press 13 can be a common mechanical press, or a vacuum press, or a pneumatic press, or a hydraulic press, or a press integrated with hydraulic and vacuum presses together, or a press integrated with hydraulic and pneumatic presses, or a press integrated with hydraulic and common mechanical pressed together and so on.

FIG. 9 is a side view showing the sealed connection of the vacuum box and the hydraulic presses of the present invention, it illustrates that the conventional hydraulic presses 13 are mounted on the vacuum box 14 with bolts 20 cooperating to the seal loop 13.1 to connecting into one body integrally, the pressure bar 13.2 of the hydraulic press 13 passes through the roof side 14.3 of the vacuum box 14 so that the tip end of pressure bar 13.2 stretches into the inside of the vacuum box 14 to join with the combined base 15 for connecting to the guide pillars 7 of the top board 6.

### THE FIRST PREFERRED EMBODIMENT

Referring to FIG. 1, FIG. 2, FIG. 4 and FIG. 5, the method of the present invention is described in detail as followings:

Take 20 pieces of artificial stone sheets out as two in one set, firstly coat SY-21 cold binder on the contacting surfaces of said artificial stone sheets; next stack all sets of laminated boards 10 up on the top surface of the pressure block 5 isolated by the plastic film 11 between two adjacent sets of laminated boards for avoiding the binder exuding from the interstices of the sheets to glue the adjacent sets of the laminated boards 10 together; after stacking all the sets of laminated boards 10 up, secure in the bolts 8.1 of the fasteners 8 on the pressure block 5 of the trailer carrier 1, sequentially put the top board 6 on the bolts 8.1 to press on the stacked laminated boards 10, and secure on the nuts 8.2 respectively keeping in loose state in this time, said top board 6 is made of cast-iron; then place the trailer carrier 1 stocked with the stacked laminated boards 10 into the inside of the box vacuum pressure device 18, by plugging the latches 9 in the combined base 15 of the box vacuum pressure device 18 is connected to the guide pillars 7 of the top board 6, next lift the top board 6 up by the hydraulic presses 13 of the box vacuum pressure device 18 so that the top board 6 is kept more than 1 cm distance from the top surface of the stacked laminated boards 10 for preventing the binder layer between the sheets from affecting by the pressing force coming from the top weight of the top board 6 as vacuuming; then close the door 14.1 and windows 14.2 of the vacuum box up, the box vacuum pressure device 18 can carry out vacuuming process to get −0.1 MPa shown on the vacuum-meter taking about 13 minutes in order that the inside of the box vacuum pressure device 18 is guaranteed enough vacuum; then under the vacuum condition the hydraulic presses 13 of the box vacuum pressure device 18 stars to press the stocked laminated boards 10 coated with cold binder in the briquette process with 30 Tons pressure; after exerting pressing force, the vacuum condition can be removed in the inside of the box vacuum pressure device 18, open the windows 14.2 of the box vacuum pressure device 18, and via them the operator can secure the fasteners 8 in for keeping the pressure exerting on the stacked laminated boards 10 after removing the pressure coming from the hydraulic press 13 of the box vacuum pressure device 18, so that the stacked laminated boards stocked on the trailer carrier 1 are exerted with pressing force by the trailer carrier 1 its own after the trailer carrier 1 is took out of the vacuum box of the box vacuum pressure device 18, in order to guarantee the binder layers between the sheets of the laminated boards 10 are solidified under the pressure fully; after securing the fasteners 8 in, remove the latches 9 from the locking configuration to depart the combined base 15 from the guide pillars 7 of the top board 6 so that the pressing force coming from the hydraulic presses 13 can be removed; then the door 14.1 is opened, the trailer carrier 1 can be exited out of the box vacuum pressure device 18 for being ready to place the next stacked trailer carrier 1 in for next circulation; the trailer carrier 1 exited from the box vacuum pressure device 18 is placed in idle state for waiting for the SY-21 cold binder layers solidified completely, it will take about 3 hours; after the binder is solidified fully, secure out the fasteners 8, remove the top board 6, the finished artificial stone laminated boards 10 can be took out from the trailer carrier 1 for emptying the trailer carrier 1 for reloading stacked sheets of the laminated boards 10 in next circulation; the finished laminated board 10 will be cut off the solidified binder exuded out along the edges by the trim cutter to become a quantified goods for entering the storing house.

Said SY-21 cold binder can be bought in the Chinese market.

### THE SECOND PREFERRED EMBODIMENT OF THE PRESENT INVENTION

Referring to FIG. 1, FIG. 3, FIG. 6 and FIG. 7, the method of the present invention is described in detail as followings:

Take 15 pieces of artificial stone sheets and 15 pieces of fire-proof boards out as one artificial stone sheet and one fire-proof board in one set of the laminated board 10, firstly coat E-7-2 thermosetting binder on the contacting surfaces of one artificial stone sheet and one fire-proof board respectively; next stack all sets of laminated boards 10 up on the top surface of the pressure block 5 within one set of the laminated board 10 is sandwiched by two conducting blocks 12 respectively; after stacking all the sets of laminated boards 10 up, secure in the bolts 8.1 of the fasteners 8 on the pressure block 5 of the trailer carrier 1, sequentially put the top board 6 on the bolts 8.1 to press on the stacked laminated boards 10, and secure on the nuts 8.2 respectively keeping in loose state in this time, said top board 6 is made of cast aluminum alloy; then place the trailer carrier 1 stocked with the stacked laminated boards 10 into the inside of the box vacuum pressure device 18; then close the door 14.1 and windows 14.2 of the vacuum box up, the box vacuum pressure device 18 can carry out vacuuming process to get −0.1 MPa shown on the vacuum-meter taking about 15 minutes in order that the inside of the box vacuum pressure device 18 is guaranteed enough vacuum; then under the vacuum condition the hydraulic presses 13 of the box vacuum pressure device 18 stars to press the stocked laminated boards 10 coated with thermosetting binder in the briquette process with 35 Tons pressure; after exerting pressing force, the vacuum condition can be removed in the inside of the box vacuum pressure device 18, open the windows 14.2 of the box vacuum pressure device 18, and via them the operator can secure the fasteners 8 in for keeping the pressure exerting on the stacked laminated boards 10 after removing the pressure coming from the hydraulic press 13 of the box vacuum pressure device 18, so that the stacked laminated boards stocked on the trailer carrier 1 are exerted with pressing force by the trailer carrier 1 its own after the trailer carrier 1 is took out of the vacuum box of the box vacuum pressure device 18, in order to guarantee the binder layers between the sheets of the laminated boards 10 are solidified under the pressure fully; after securing the fasteners 8 in, the pressing force coming from the hydraulic presses 13 can be removed; then the door 14.1 is opened, the trailer carrier 1 can be exited out of the box vacuum pressure device 18 to be pushed to the heating solidifying site, in there the oil-pipes of the conducting blocks 12 are connected to the connectors 12.1 located on the wall of the vacuum box respectively to form a hot oil loop in the conducting blocks 12 with the outer hot oil resource, in order to make the conducting blocks 12 transfer the heat power to the laminated boards 10 to solidify the thermosetting binder completely with 100° C. in temperature for 2 hours; after the trailer carrier 1 is exited from the box vacuum pressure device 18, the vacuum box is ready to place the next stacked trailer carrier 1 in for next circulation; the trailer carrier 1 exited from the box vacuum pressure device 18 is placed in heating solidifying site for waiting the E-7-2 thermosetting binder layers solidified completely in the heating solidifying site; after the binder is solidified fully, secure out the fasteners 8, remove the top board 6, the finished artificial stone laminated boards 10 can be took out from the trailer carrier 1 for emptying the trailer carrier 1 for reloading stacked sheets of the laminated boards 10 in next circulation; the finished laminated board 10 will be cut off the solidified binder exuded out along the edges by the trim cutter to become a quantified goods for entering the storing house.

Said E-7-2 thermosetting binder can be bought in the Chinese market.

### THE THIRD PREFERRED EMBODIMENT

Referring to FIG. 1, FIG. 2 and FIG. 8, the method of the present invention is described in detail as followings:

Take 5 pieces of marble sheets and 10 pieces of artificial stone sheets out as one piece of marble sheet and two pieces of artificial stone sheets in one set, firstly coat SY-21 cold binder on the contacting surfaces of said artificial stone sheets and said marble sheet in one set; next stack all sets of laminated boards 10 up on the top surface of the pressure block 5 in the way as same as the first embodiment; after stacking all the sets of laminated boards 10 up, cover the casing vacuum pressure device 18′ on the pressure block 5 to take sealing connection by engaging the seal loop 19 of the vacuum casing on the pressure block 5 of the trailer carrier 1, then via opening the windows 14.2 of the casing vacuum pressure device 18′, plugging the latches 9 in connects the combined base 15 of the hydraulic presses 13 to the guide pillars 7 of the top board 6, next close the windows 14.2 of the vacuum casing up, the casing vacuum pressure device 18′ can carry out vacuuming process as same as the steps described in the first preferred embodiment; then under the vacuum condition the hydraulic presses 13 of the casing vacuum pressure device 18′ stars to press the stocked laminated boards 10 coated with cold binder in the briquette process with 20 Tons pressure; after exerting pressing force, the vacuum condition can be removed in the inside of the casing vacuum pressure device 18′, open the windows 14.2 of the casing vacuum pressure device 18′, and via them the operator can secure the fasteners 8 in for keeping the pressure exerting on the stacked laminated boards 10 after removing the pressure coming from the hydraulic presses 13 of the casing vacuum pressure device 18, so that the stacked laminated boards 10 stocked on the trailer carrier 1 are exerted with pressing force by the trailer carrier 1 its own after the vacuum casing of the casing vacuum pressure device 18′ is removed, in order to guarantee the binder layers between the sheets of the laminated boards 10 are solidified under the pressure fully; after securing the fasteners 8 in, remove the latches 9 from the locking configuration to depart the combined base 15 from the guide pillars 7 of the top board 6, remove the casing vacuum pressure device 18′ and exit the trailer carrier 1 to one side for the casing vacuum pressure device 18′ being ready to place the next stacked trailer carrier 1 in for next circulation; the trailer carrier 1 exited from the casing vacuum pressure device 18′ is placed in idle state for waiting for the SY-21 cold binder layers solidified completely, it will take about 3 hours; after the binder is solidified fully, secure out the fasteners 8, remove the top board 6, the finished artificial stone laminated boards 10 can be took out from the trailer carrier 1 for emptying the trailer carrier 1 for reloading stacked sheets of the laminated boards 10 in next circulation; the finished laminated board 10 will be cut off the solidified binder exuded out along the edges by the trim cutter to become a quantified goods for entering the storing house.

### THE FOURTH PREFERRED EMBODIMENT

FIG. 9 is a side view showing the sealed connection of the vacuum box and the hydraulic presses of the present invention, it illustrates that the conventional hydraulic presses 13 are mounted on the vacuum box 14 with bolts 20 cooperating to the seal loop 13.1 to connecting into one body integrally, the pressure bar 13.2 of the hydraulic press 13 passes through the roof side 14.3 of the vacuum box 14 so that the tip end of pressure bar 13.2 stretches into the inside of the vacuum box 14 to join with the combined base 15 for connecting to the guide pillars 7 of the top board 6; said hydraulic press 13 is a conventional hydraulic press.

Obviously, above-mentioned preferred embodiments of the present invention are some special examples trying to describe the present invention, not to be used for limiting the process way of the present invention. To the common technicians involving in this field, the other changes in the structure also can be made up basing on the description further. So all the embodiments, just for this reason, can not be explained into detail or covering everything. But, based-on the base spirit of the present invention, all the deducted changes are in the claimed range of the present invention.

What is claimed is:

1. A method for manufacturing laminated board, wherein, including the following steps:
a) stack the sheets coated with binder of the laminated board up on the pressure block of the trailer carrier;
b) secure in the blots of the fasteners on the pressure block, fit the top board over the bolts, secure on nuts;
c) place the trailer carrier stocked with the stacked laminated boards into the inside of the vacuum pressure device;
d) exhaust out air of at the cavity by the vacuum pressure device;
e) briquette the sheets coated with binder into the laminated boards by the vacuum pressure device under the vacuum condition;
f) remove the vacuum condition from the vacuum pressure device;
g) secure in the fasteners on the top board to keep the pressure exerting on the stacked laminated boards;
h) remove the pressure coming from the press of the vacuum pressure device;
i) exit the trailer carrier from the vacuum pressure device for waiting to the binder solidifying in cold or heating;
j) Move out the fasteners, the top board from the top side of the trailer carrier sequentially; take the finished laminated boards out.

2. A method for manufacturing laminated board as claimed in claim 1, wherein, said stacking and gumming step operated on the pressure block of the trailer carrier includes that coating blinder over the contacting surface of the sheets of the laminated board before stacking the sheets up; also includes taking plastic film to isolate two adjacent gummed laminated board as in stacking operation, or sandwiching a set of the stacked gummed laminated board between two conducting blocks;

3. A method for manufacturing laminated board as claimed in claim 1, wherein, said step of putting the trailer carrier loaded with a set of stacked laminated boards at inside of the vacuum pressure device includes that after placing the trailer carrier loaded with a set of stacked laminated boards into the inside of the vacuum pressure device, by plugging the latches the combined base of the hydraulic actuating mechanism is connected to the guide pillars of the top board;

4. A method for manufacturing laminated board as claimed in claim 1, wherein, said removing the pressure coming from the vacuum pressure device step in-cludes when the combined base of the hydraulic actuating mechanism is con-nected to the guide poles of the top board by plugging the latches in, if want to disconnect the connection such as drawing the latches out, firstly the pressure force coming from the hydraulic actuating mechanism has to be removed, then draw the latches out, next separate the combined base of the hydraulic actuating mechanism out from the guide poles of the top board;

5. the apparatuses used for carry out above-mentioned method include a vacuum pressure device and trailer carriers, wherein said vacuum pressure device is combined a vacuum device and a set of hydraulic actuating mechanism inte-grally into one body is comprised of a vacuum device used for exhausting out air, and hydraulic actuating mechanism used to briquette the sheets of the laminated boards stacked on the trailer carrier; said trailer carrier includes wheels used for running, a carriage used for placing a pressure block on, spring-strip suspensions connecting said carriage to the wheels respectively for damping as running, a pressure block set upon the carriage used for bearing all sets of laminated boards and a top board pressing all sets of laminated boards set, and fasteners secured on the pressure block rightly upward for matching with the pressure block and the top board separately;

6. The apparatus used for manufacturing laminated board as claimed in claim 5, wherein said vacuum device of said vacuum pressure device also can be vac-uum box, vacuum cabin or vacuum casing, among of them, said vacuum box and vacuum cabin have a door individually for the trailer carrier entering and ex-iting, and windows facilitating to securing operation, and also have track-way providing the guide way for the trailer carrier entering and exiting, and a pair of bearing plates for bearing pressure coming from the vacuum pressure device; said vacuum casing has windows facilitating to the securing operation and seal loop at the bottom side for matching on the top surface of the pressure block in seal connection;

7. The apparatus used for manufacturing laminated board as claimed in claim 5, wherein in said vacuum pressure device the presses are joined to the vacuum device in sealing connection, and the pressure bars of the presses pass through the wall of vacuum device stretching into the inside, or said presses are mounted on the inside wall of the vacuum device in connection;

8. The apparatus used for manufacturing laminated board as claimed in claim 5, wherein the pressure bars of said presses are connected to a combined base with the end for indirectly connecting to the guide pillars of the top board, said top board has said guide pillars built on the top side used for connecting to the combined base of said presses, and latches used for locking or releasing the connection of the combined base and the guide pillars;

9. The apparatus used for manufacturing laminated board as claimed in claim 5, wherein also includes conducting blocks used for heating and solidifying the thermosetting binder layer between the sheets of the laminated board, also in-cludes the track-way used for carrying the trailer carrier.
